(19) United States
(12) Patent Application Publication
(10) Pub. No.: US 2023/0315596 A1
(43) Pub. Date: Oct. 5, 2023

(54) PLATFORM AND PLATFORM COMPONENT DEBUG BY MULTIPLE DEBUGGING SYSTEMS

(71) Applicant: Intel Corporation, Santa Clara, CA (US)

(72) Inventors: Aruni P. Nelson, Folsom, CA (US); Enrico David Carrieri, Placerville, CA (US); Rolf Kuehnis, Portland, OR (US)

(21) Appl. No.: 18/332,420

(22) Filed: Jun. 9, 2023

(51) Int. Cl. G06F 11/22

(52) U.S. Cl. CPC G06F 11/2273

(57) ABSTRACT

Embodiments herein relate to a logic configured to: identify, based on a header of a first packet, that the first packet is related to a first debug process of a component to which the logic is communicatively coupled, wherein the first debug process is performed by a first DTS; identify, based on a header of a second packet, that the second packet is related to a second debug process of the component, wherein the second debug process is performed by a second DTS; route, based on the identification that the first packet is related to the first debug process, the first packet between the component and the DTS; and route, based on the identification that the second packet is related to the second debug process, the second packet between the component and the DTS. Other embodiments may be described and/or claimed.

### BACKGROUND

Embodiments of the present disclosure generally relate to the field of debugging and, particularly, debugging systems that may be used to debug a platform and/or one or more components of such a platform.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example and not by way of limitation in the figures of the accompanying drawings.

FIG. 1 illustrates an example of a parallel configuration of a debug probe, in accordance with various embodiments.

FIG. 2 depicts an example of an alternative configuration of a debug probe, in accordance with various embodiments.

FIG. 3 depicts an example of an alternative parallel configuration of a debug probe, in accordance with various embodiments.

FIGS. 4A, 4B, 4C, and 4D (collectively, “FIG. 4”) depict examples of debug configurations, in accordance with various embodiments.

FIG. 5 depicts an alternative example of a debug configuration, in accordance with various embodiments.

FIG. 6 depicts an alternative example of a debug configuration, in accordance with various embodiments.

FIG. 7 depicts an example debug-related process flow that may be used with the debug configuration of FIG. 6, in accordance with various embodiments.

FIG. 8 depicts an alternative example of a debug configuration, in accordance with various embodiments.

FIG. 9 depicts an example debug-related process flow that may be used with the debug configuration of FIG. 8, in accordance with various embodiments.

FIG. 10 depicts an example data structure that may be used by a debug system, in accordance with various embodiments.

FIG. 11 illustrates an example process . . . .

### DETAILED DESCRIPTION

Embodiments described herein may include apparatus, systems, techniques, or processes that are directed to platform or platform component debugging or test systems.

As used herein, the term “platform” may refer to a functional system that may include one or more boards, and one or more components positioned on the one or more boards. In embodiments, one or more of the boards and/or components may be debugged. The element(s) that are being debugged (e.g., the board(s) and/or component(s)) may be referred to as the target system (TS), and may be referred to as a “device under test” or “DUT.”

As used herein, the term “component” may refer to an independent compute element (e.g., a microcontroller, a microprocessor, etc.), which may be debugged. Such a component may be, for example, in an independent package (e.g., a system-on-chip (SoC), a platform controller hub (PCH), a microcontroller such as an embedded controller (EC), dedicated graphics processing unit (dGPU), field programmable gate array (FPGA), etc.). Additionally or alternatively, such a component may be in an integrated sensor hub (ISH), an audio and context engine (ACE), a computing core, a converged security and manageability engine (CSME), a power management controller (PMC), an operating system security engine (OSSE), etc.

Generally, legacy implementations may support debug of platforms using one of the following example configurations:
one debug and test system (DTS) that is configured to debug a single platform or a single component within a platform; or
multiple debuggers used to respectively debug different platform components.

However, such legacy implementations may not provide a configuration wherein multiple DTSs may debug the same TS (e.g., the same platform(s) and/or same platform component(s)).

Additionally, the MIPI Alliance may define specifications related to debug technologies and protocols for debugging. However, such legacy definitions may not provide a standard mechanism for a secure, multi-access, collaborative debug of platforms and/or platform components.

Embodiments herein may relate to collaborative debug of components from different vendors on a platform. Embodiments may further relate to collaborative debug of portions of the component(s) and/or platform(s) that may be standardized by MIPI Alliance.

Generally, DTS-legacy solutions may only allow a DTS to debug a TS either through a direct connection or a remote connection. Additionally, legacy DTS-related solutions may allow a DTS to debug multiple TSs over a single connection, or debug multiple TSs provided they are connected over different connections.

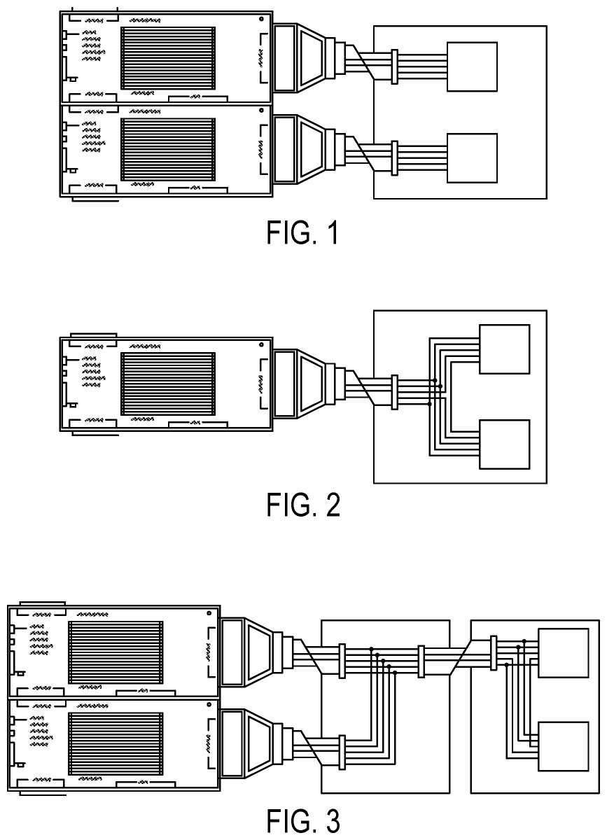

FIGS. 1-3 depict example configurations wherein a probe of a DTS may couple with a platform and/or one or more components of such a platform. For example FIG. 1 depicts an example configuration wherein there are two probes, and each probe is communicatively coupled with (e.g., operable to test) a single TS.

FIG. 2 depicts an alternative configuration which may be referred to as a joint test action group (JTAG) chain configuration, a daisy-chained configuration, a star configuration, etc. In this embodiment, a single probe may be communicatively coupled with two different TSs (e.g., components of a platform in this example), and each of the TSs may be communicatively coupled with one another. The performance of the solution of FIG. 2 may be limited by factors such as the topology of the platform. Specifically, the topology (i.e., the routing between the DTS and the different TSs) may affect the electrical properties of the signals between the DTS and the TSs. For example, the length of routing between the DTS and a TS may affect the maximum possible speed of signaling between the DTS and the TS because longer routes may have more electrical resistance and, thus, cause the signaling to be slower than shorter routes.

FIG. 3 depicts an alternative configuration wherein multiple probes may be used. Specifically, multiple probes may be communicatively coupled with multiple TSs on a single debug port. In this configuration, only one probe may be active, while the other probe is tri-stated. As used herein, “tri-stated” may refer to a configuration wherein the DTS is not driving the signals between the DTS and a TS.

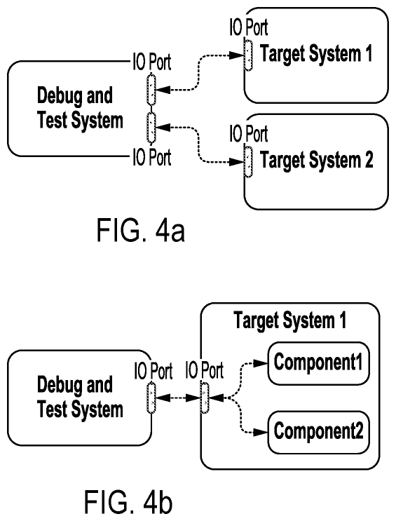

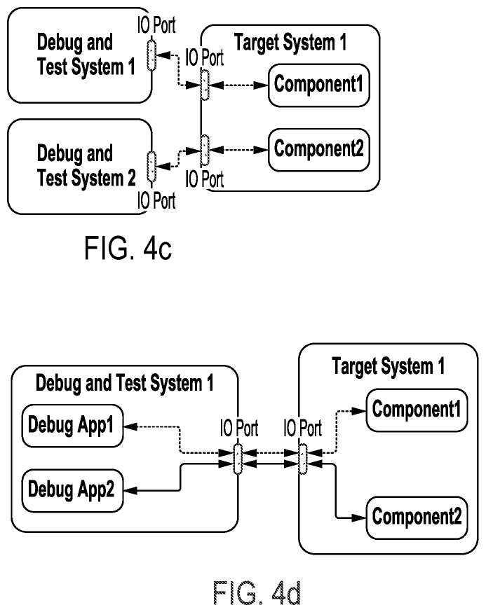

FIGS. 4a, 4b, 4c, and 4d (collectively, “FIG. 4”) depict examples of debug configurations, in accordance with various embodiments. Specifically, FIG. 4a depicts an example configuration wherein a single DTS is configured to debug multiple TSs over separate debug connections. That is, a different debug connection is used for communicative coupling of the DTS to one TS than is used for communicative coupling of the DTS to another TS. FIG. 4b depicts an example configuration wherein a single DTS is configured to debug TS s over a single debug connection to a platform that internally connects to multiple TSs (e.g., components).

FIG. 4c depicts an example configuration where multiple DTS are configured to debug multiple components of a single TS over separate debug connections. That is, a first DTS is configured to debug a first TS over a first connection, and a second DTS is configured to debug a second TS over a second connection.

FIG. 4d depicts an example configuration wherein a single DTS is configured to debug multiple TSs over a single physical connection (e.g., between one input/output (I/O) port of the DTS and one I/O port of the platform). However, as shown, the DTS may be running multiple debug applications that are separately logically coupled with different TS s (e.g., different components of the platform).

However, the above configurations may experience one or more disadvantages. For example, such configurations may not include a mechanism to connect multiple DTSs to the same TS, where the multiple DTS are configured to debug the same TS. Similarly, such configurations may not include a mechanism to connect multiple DTSs to the same TS such that the multiple DTSs are configured to debug the same TS at least partially simultaneously. Rather, in the approaches described above, each debug probe may need physical access to the debug port of the platform, which may limit the usability of the solution.

Additionally, legacy debug approaches over a network may not allow for or address collaboration between individual DTSs. Access to the TS may be based on dedicated access to a single debugger at a time, and any collaboration may be based on configurations such as screen sharing.

Embodiments herein relate to a secure, multi-access, collaborative debug solution. Embodiments herein may be used, for example, for collaborative remote debug configurations (e.g., wherein multiple DTSs can be debugging the same TS, even if at least one of the DTSs is not in the same physical location as the TS).

Embodiments herein may relate to or include one or more of the following elements or characteristics:
Logic (which may be implemented as hardware, firmware, software, or some combination thereof) implemented in the TS. The logic may provide secure debug access, filters, routers, and may arbitrate debug commands or messages from different DTSs. Such commands or messages may include, for example, authentication, establishment of a secure session, etc. This logic may be referred to herein as “Debug Access Filter, Router, and Arbiter Logic” and may be shortened to “DAFRA logic” for the sake of discussion herein, although it will be recognized other embodiments or implementations may refer to the DAFRA logic by some other name.
Logic (which may be implemented as hardware, firmware, software, or some combination thereof) implemented in the components that are being debugged. The logic may be configured to handle multiple accesses from different DTSs, and may be configured to bifurcate debug sessions where appropriate. This logic may be referred to herein as “Multi-Access Handler Logic,” or may be shortened to “MAH logic” for the sake of discussion herein, although it will be recognized that other embodiments or implementations may refer to the MAH logic by some other name.
Message exchanges implemented at the debug protocol level to enable detection and/or setup of collaborative debug sessions.
An interface and/or associated protocol logically positioned between one or both of the above-described logics and the component that is being debugged. The interface and/or protocol may be configured to facilitate multi-access and arbitrated transmission of commands to, and/or responses from, the component.

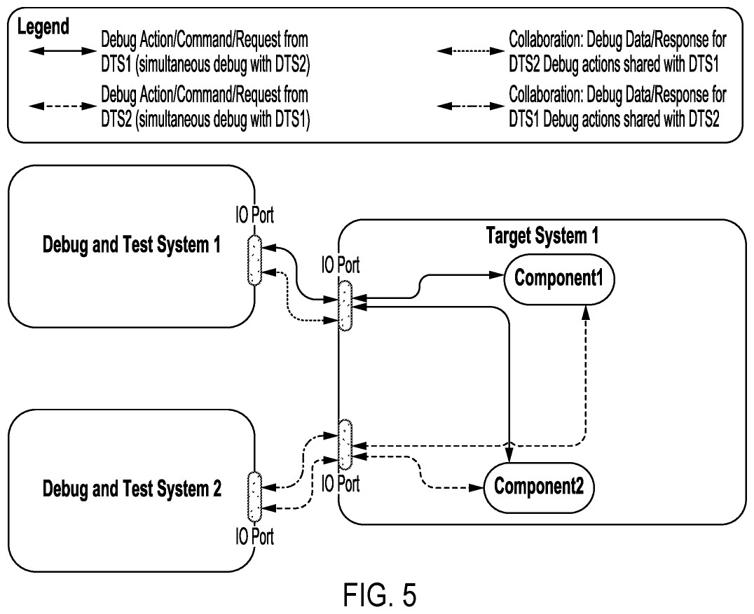

As a result, embodiments herein may enable the debug configuration depicted in FIG. 5. Specifically, as may be seen in FIG. 5, embodiments may enable multiple DTSs to simultaneously test multiple components of a DTS, and to share the results of that testing with one another.

Embodiments may provide a number of advantages. For example, embodiments may help alleviate the supply chain shortage, by allowing a single DTS to be used collaboratively, instead of legacy approaches that may require a single DTS per debugger. Additionally embodiments may result in a cost-effective debug solution. Embodiments may further result in faster debug experiences, thereby shortening time-to-market of the platforms and/or associated components.

Generally, embodiments herein may be described with respect to various functions and elements. One such element, as described above, may be the DAFRA logic. In embodiments, the DAFRA logic may be implemented in the TS (e.g., in a platform) and may function as one or more of a filter, router, and arbiter.

In some embodiments, the DAFRA logic may expose a new register set. The register set may describe platform support for standard collaborative debug. The register set may be configurable, and may be usable to enable or disable the collaborative debugging feature. The register set may additionally be usable to configure collaborative debugging attributes such as the level of collaborative debugging, and/or components or elements within a component that can be collaboratively debugged.

In some embodiments, the DAFRA logic may be configured to perform an authentication and debugging function for test systems. Such a function may not preclude mutual authentication. Specifically, in some cases, the TS may verify the entity of the user of the DTS to ensure that such entity is an authorized debugger (e.g., through comparison of a credential of the entity against a registry of pre-identified authorized debuggers, or through some other type of authentication). However, in some embodiments, it may also be desirable for the DTS to verify the TS to ensure that the TS is the expected component/platform. Mutual authentication refers to the situation wherein the DTS and the TS are enabled to authenticate one another. Such authentication may be, for example, configurable in the DAFRA logic (e.g., at runtime, compile time, or some other form of configuration).

The DAFRA logic may also be configured to establish a secure debug session between the DTS and the TS using standards such as the distributed management task force (DMTF) security protocol and the security protocol and data model (SPDM) specification. The DAFRA logic may also be configured to establish the ability to share debug responses across DTSs from components under debug (presuming that such sharing is authorized). The DAFRA logic may also be configured to establish collaborative session(s) between various DTSs for the purposes of allowing collaborative debug functionality across the DTSs. The DAFRA logic may also be configured to schedule and/or arbitrate the transmission or reception of debug-related commands and/or responses between multiple DTSs and one or more components that are being debugged.

In some embodiments, the DAFRA logic may be configured to manage debug regions across the DTSs to prevent unwanted overwrites, as described in further detail below. Specifically, the DAFRA logic may include filtering and/or routing capabilities that can be configured with metadata and/or a “configuration file” that includes details about debuggable platform components. The metadata and/or configuration file may be part of a data packet header, part of the register, or otherwise appended to or associated with data packets related to the debugging functionality such as debug commands, requests, responses, etc.

The metadata or configuration file may be usable to indicate, for example, which capabilities and/or actions may require independent access, and which capabilities and/or actions can handle multiple/simultaneous access. For example, the configuration file may be used to configure a particular debug capability as something that only one debugger may access at a time, or as something that multiple debuggers may at least partially concurrently access.

In some embodiments, the capabilities and/or actions may be programmed through a debug application (e.g., a user-facing software component) into the DTS. In some embodiments, the debug application may additionally append the identifier (e.g., in the header of various data packets related to debugging or into the above-mentioned register). The identifier may be used to identify which capabilities and/or actions are permitted for simultaneous and/or multiple access. In some embodiments, a trusted component in the platform may manage these capabilities. As used herein, the term “trusted component” may refer to a security agent that is configured to handle security/protections for the platform, and may be referred to as a platform root of trust (PRoT).

In some embodiments, the DAFRA logic may be configured to manage the debug session. For example, the DAFRA logic may append, remove, and/or process an identifier (e.g., in the header of a debug message such as a debug command or request) to maintain debug regions and route debug requests/commands (e.g., to or from a DTS and a component/TS).

As used herein, a “debug region” may refer to elements such as specific code region(s) (e.g., specific areas of memory used for storing program code in a microcontroller), data region(s) (e.g., specific areas of memory used for storing data in a microcontroller), a set of one or more registers, specific locations in static random access memory (SRAM) of a component, etc. that are related to a particular debug process. It will be understood that, in some embodiments, a single component may include a plurality of debug regions

For example, As noted above, in some embodiments a MAH Logic may be configured to bifurcate debug sessions (i.e., split a single debug process into multiple debug processes) to create two instances of the debug sessions. In this case, each of the debug sessions may have its own debug region. For the sake of security and preventing errors that may be caused by overwriting, it may be desirable to enforce that the debug regions do not overlap (e.g., do not share one or more of the types of memory locations listed above). The DAFRA logic may be configured to route the various requests, commands, or data related to a debug session or debug region to ensure that this overlap does not occur.

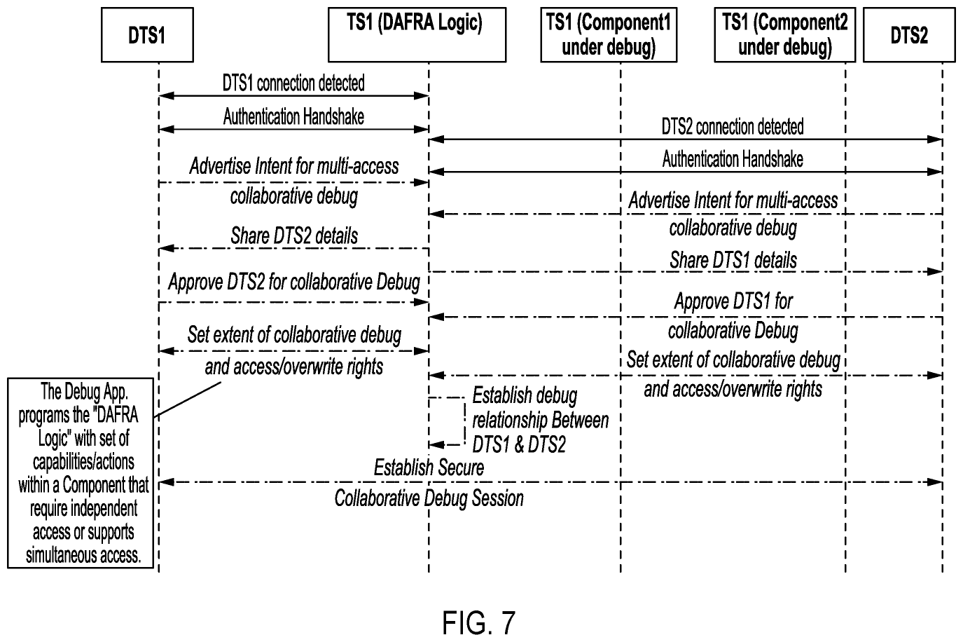

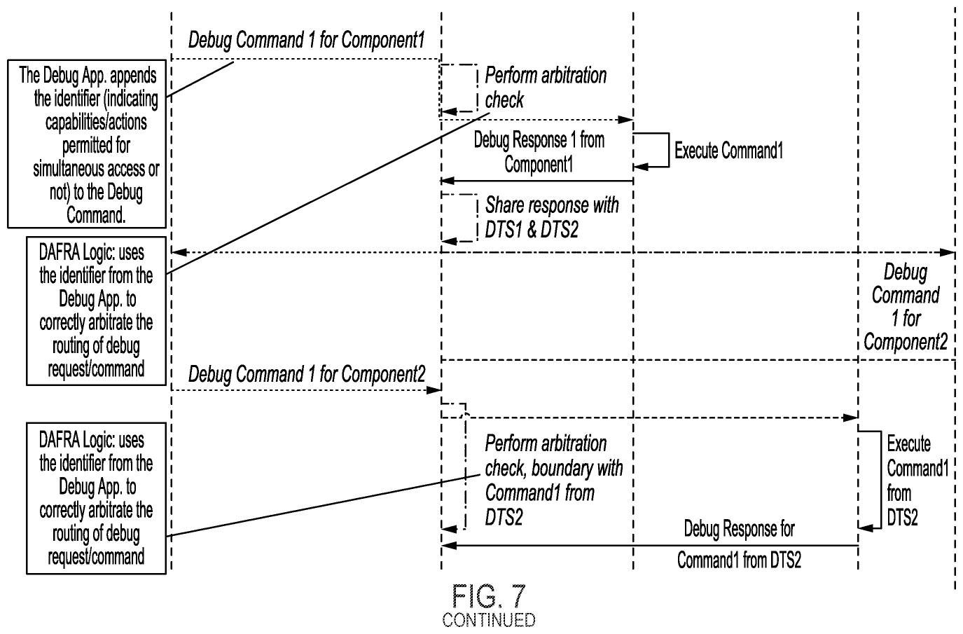

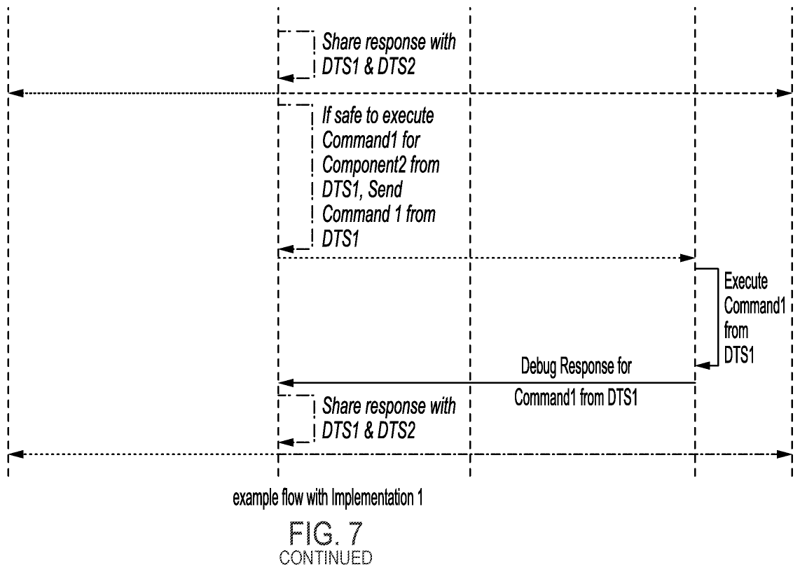

Some embodiments may include the MAH Logic as previously described. The MAH Logic may be implemented in various TSs that are to be debugged, and may be configured to support or handle multiple accesses from a single debugger or from a plurality of debuggers. FIG. 7 shows an example of this support from a plurality of debuggers (e.g., DTS1 on the left and DTS2 on the right).

As noted above, some embodiments may include message exchanges that are implemented at the debug protocol level. The message exchanges may be used for authentication using, for example, the SPDM specification or some other specification. The message exchanges may additionally/alternatively be used to allow information exchange between the DTS and the DAFRA Logic (and/or the MAH Logic) to enable or disable multi-access, DTS priority levels, etc. The message exchanges may additionally/alternatively be used to enable or disable collaborative debug sessions across DTSs. The message exchanges may additionally or alternatively be used to allow communication between the DTS and the DAFRA Logic (and/or the MAH Logic) to allow or disallow debug response sharing between DTSs. The message exchanges may additionally/alternatively be used to enforce separation of different debug regions, as described above.

As noted above, some embodiments may also include an interface or protocol between the DAFRA Logic (and/or the MAH Logic) and one or more components of the TS. The interface and/or protocol may be used to facilitate multi-access and arbitrated command or response transmission such as utilizing parameters in debug message headers.

### First Example Implementation

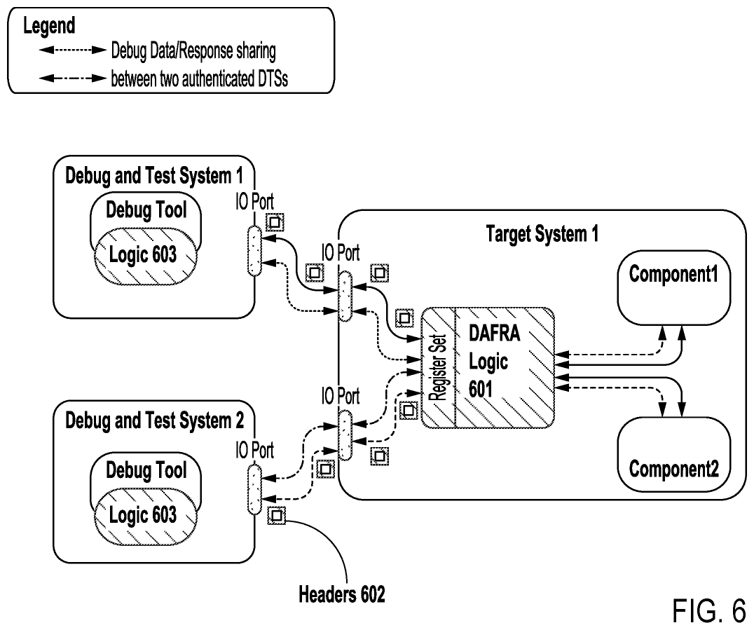

An example implementation of the DAFRA logic 601 is depicted in FIG. 6. Specifically, FIG. 6 depicts an example of how such DAFRA logic 601 may use Time slicing to manage Debug Regions during a collaborative debug session. For example, a DTS/owner/Collaborative Debugger/etc. may perform an atomic Read-Modify-Write operation, then that would be completed without interruption. If another collaborator tries to access the same capability, such access may be delayed until a completion notification is sent to other collaborators before executing the new Read-Modify-Write or Write Operation request to the same capability.

It will be noted that FIG. 6 depicts DAFRA logic positioned in a TS (depicted as “Target System 1.” The TS may be communicatively coupled with two separate DTSs (depicted as “Debug and Test System 1,” which may be referred to as DTS1, and “Debug and Test System 2,” which may be referred to as DTS2. One or both of the DTSs may include a logic 603, which may be implemented as hardware, software, firmware, and/or some combination thereof. The logic 603 may be configured to configure the DAFRA logic in the TS with metadata and/or a configuration file. The metadata/configuration file may include indications of one or both of (1) one or more capabilities/actions that require independent access by a single DTS; and (2) one or more capabilities/actions that may allow for access by multiple DTSs, whether sequentially or at least partially concurrently. The logic 603 may additionally append a header to debug related commands/requests/etc. with one or more identifiers that indicate capabilities/actions that are permitted for at least partially concurrent access. FIG. 6 further depicts indicators 602 that show changes in related debug request packet(s), commands, or responses that include a header with the previously-mentioned identifier. It will be understood that, although FIG. 6 illustrates connections between the DTSs and the TS via I/O ports, in other embodiments such connections may be remote (e.g., over a wireless link such as a cellular link, a bluetooth link, a wifi link, etc.).

An example use-case of this implementation may include the situation where DTS1 is performing run-control debug, and DTS2 may be capturing trace data (e.g., data generated by the TS and transmitted to the DTS for the purpose of analysis of behavior of a TS).

If the DAFRA logic 601 establishes a secure relationship between DTS1 and DTS2 for purposes of sharing debug responses from component under debug, then the DAFRA logic 601 may further be configured to share trace messages (as may be requested by DTS2) with DTS1, and an error event encountered during run-control debug (e.g., as may be observed by DTS1) with DTS2.

Generally, the DAFRA logic 601 may perform Debug and Session management messaging to ensure coherency of debug operations across the DTSs to prevent overlap. Additionally or alternatively, the DAFRA logic 601 may relay debug messages between different DTSs. Additionally or alternatively, the DAFRA logic 601 may maintain coherency, for example, by ensuring that messages are correctly communicated between a DTS and a TS.

More generally, logic such as DAFRA logic 601, logic 603, or other logic described herein may be configured to support the following: One DTS may temporarily “own” a TS component, and in that situation other DTSs may be considered to be passive observers for that component. For example, the “owning” DTS may be allowed to perform a “destructive” task related to the component such as a write-operation, while the other DTSs may be limited to only performing non-destructive tasks such as read-operations that do not change the state of the component.

FIG. 7 illustrates an example process flow related to the above-described first example implementation of FIG. 6.

### Second Example Implementation

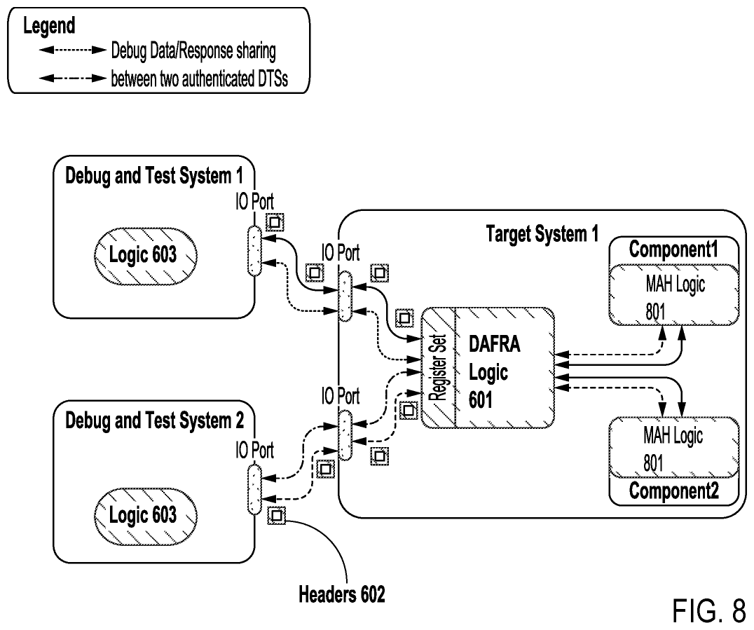

FIG. 8 depicts an alternative implementation. The implementation of FIG. 8 may be similar to that of FIG. 6, and include similar elements as shown and/or labelled. In addition, various components of the TS may include MAH logic 801, as shown. The MAH logic 801 may be configured to fork (e.g., bifurcate) the debug instances from multiple components if possible. Specifically, the MAH logic 801 may be configured to create separate instances of debug sessions, for example by virtualizing the component being debugged so that each DTS may be able to debug an instance of the component.

The MAH logic 801 may additionally or alternatively be configured to virtualize a debug instance when a state machine within the component needs to be preserved. For example, the MAH logic 801 may be configured to create a virtual instance of the component (or portion thereof).

The MAH logic 801 may additionally or alternatively be configured to serialize debug instances such that, if multiple DTSs need to access a single component (e.g., a component which may not be virtualized), then the MAH logic 801 may manage those access in sequence so that the multiple DTSs do not interfere with one another.

It will be understood that, although not shown in FIG. 8, in some embodiments the configuration may include a network of routing to various platform components under debug. Such a network may be distributed throughout the platform.

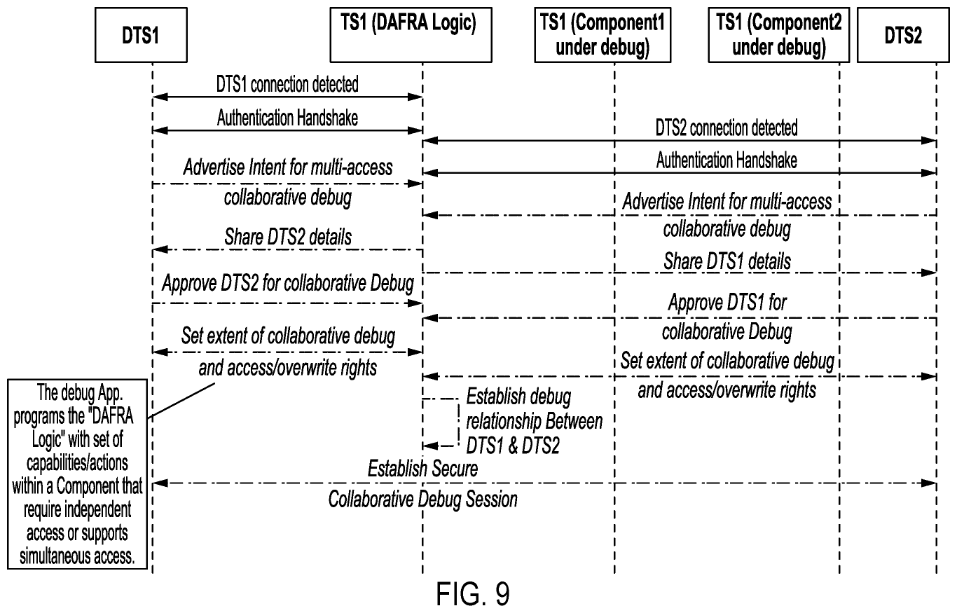

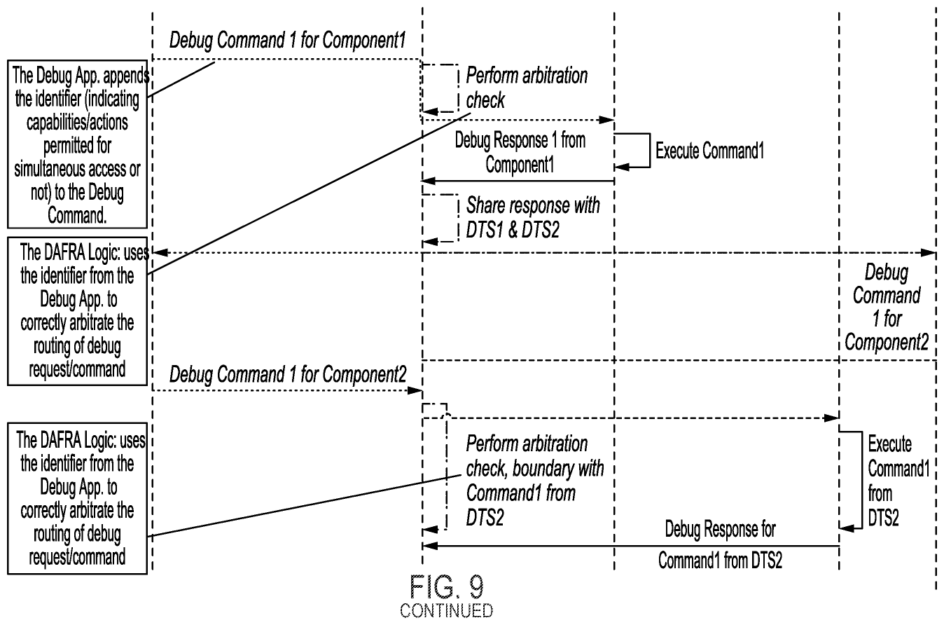

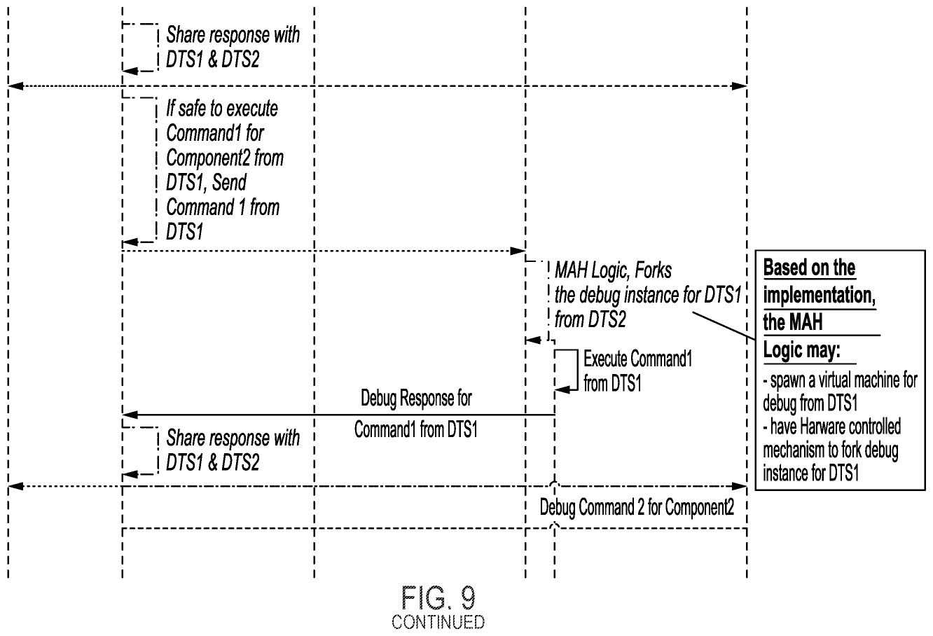

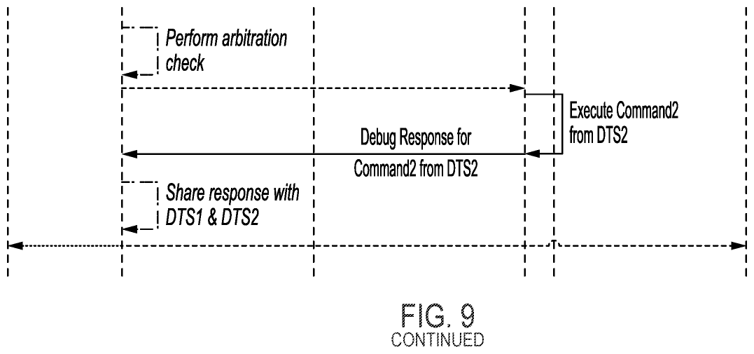

FIG. 9 illustrates an example process flow related to the above-described first example implementation of FIG. 8.

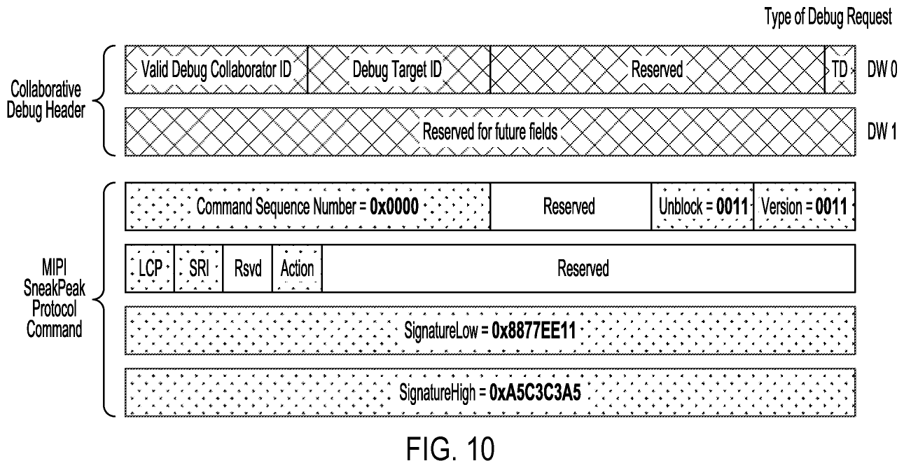

As previously mentioned, in some cases the header structure of the debug packets (e.g., commands, requests, responses, etc.) may be altered to enable collaborative debug. FIG. 10 depicts an example of such a collaborative debug header structure. The specific example of FIG. 10 may relate to a MIPI SneakPeek Protocol command for the sake of discussion, however it will be understood that this example is intended to be non-limiting and the header may additionally/alternatively be applied to other debug protocol messages.

Table 1, below describes an example of attributes in the Collaborative Debug Header Structure of FIG. 10. In some embodiments, the attributes of Table 1 may be considered to be the minimal list of attributes that may be used.

TABLE 1

| Data Word | Bits | Attribute Name | Description |
|---|---|---|---|
| 0 | 0 | TD (Type of Debug | Bit indicates the type of |
| | | Request) | debug request. If set to |
| | | | 1b the debug request is |
| | | | for collaborative debug, |
| | | | else the request is not |
| | | | for a collaborative |
| | | | debug |
| | 7:1 | Reserved bits | |
| | 23:8 | Debug Target Identifier | Debug Target ID |
| | | (ID | indicates the platform |
| | | | component which is |
| | | | under collaborative |
| | | | debug |
| | 31:24 | Valid Debug | Valid Debug |
| | | Collaborator ID | Collaborator ID |
| | | | indicates the ID a valid |
| | | | Debug Collaborator |
| | | | which was established |
| | | | as part of initial debug |
| | | | session setup |
| 1 | 31:0 | Reserved bits | |

Table 2, below, indicates an example of a register set (for example, for one or more of the registers previously mentioned). In some embodiments, this register set may be considered to indicate an example of a minimal register set.

TABLE 2

| | | Access |
|---|---|---|
| | | (RO = Read Only |
| Register Name | Description | R/W = Read/Write) |
| Collaborative Debug | Indicates if the platform supports | RO |
| Support | Collaborative Debug Capability. Which | |
| | allows access to a lookup table like | |
| | structure with valid Collaborator IDs and | |
| | permissions per Collaborator. | |
| Metadata - Component | Vendor Specific meta data describing the - | R/W |
| 1 | Collaborative Debug Capabilities, | |
| | Vendor ID of the Component under | |
| | debug, | |
| | IDs of components which support | |
| | collaborative debug. Same as the Debug | |
| | Target ID in the Header of the Debug | |
| | Request Packet | |
| | Level of Collaborative Debug for this | R/W |
| | Component | |
| | 0h = Share only responses with collaborator | |
| | 1h = Allow multi-access of protected | |
| | regions | |
| | Eh = No Collaborative Debug | |
| | Other Values = Reserved for standard | |
| | definition | |
| Metadata for other | | R/W |
| components | | |

Embodiments herein may be used in a variety of scenarios. Some scenarios may include, for example, multi-socketed central processing units (CPUs) for servers wherein a virtual machine and/or hardware may manage the debug sessions. Another scenario may include for example, collaborative debug of systems wherein components have different owners, vendors, and/or manufacturers. For example an operating system security engine (OSSE) may be owned by an independent software vendor, a power management unit (PMU) may be owned by a system-on-chip (SoC) vendor, an integrated sensor hub (ISH) may be owned by an original equipment manufacturer (OEM) or SoC vendor, an embedded controller (EC) may be owned by an EC vendor and/or an OEM, etc.

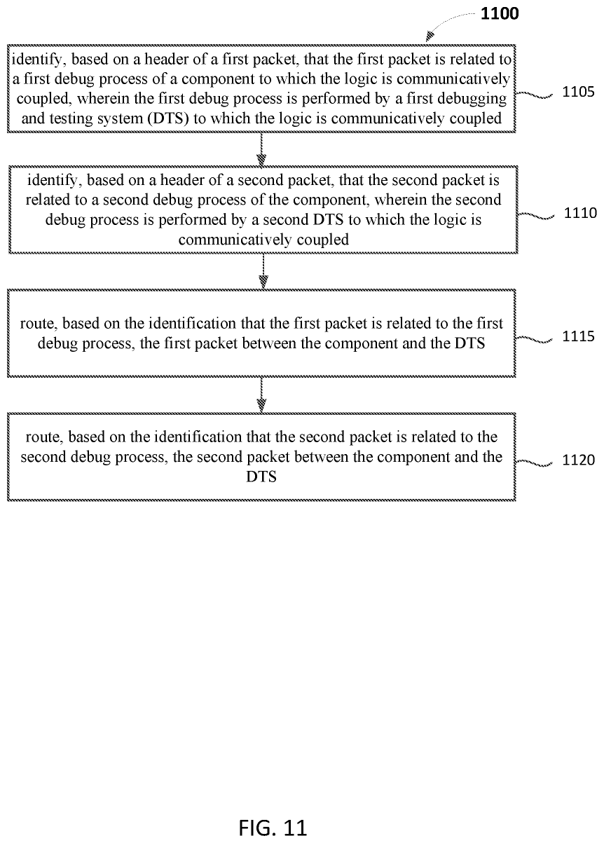

FIG. 11 illustrates an example process 1100 for debug by multiple DTSs. The process 1100 may be performed, for example, by logic such as DAFRA logic (e.g., DAFRA logic 601) as described herein.

The process 1100 may include identifying, at 1105 based on a header of a first packet, that the first packet is related to a first debug process of a component to which the logic is communicatively coupled, wherein the first debug process is performed by a first debugging and testing system (DTS) to which the logic is communicatively coupled; identifying, at 1110 based on a header of a second packet, that the second packet is related to a second debug process of the component, wherein the second debug process is performed by a second DTS to which the logic is communicatively coupled; routing, at 1115 based on the identification that the first packet is related to the first debug process, the first packet between the component and the DTS; and routing, at 1120 based on the identification that the second packet is related to the second debug process, the second packet between the component and the DTS.

It should be understood that the actions described in reference to FIG. 11 may not necessarily occur in the described sequence. For example, certain elements may occur in an order different than that described, concurrently with one another, etc. In some embodiments, the process 1100 may include more or fewer elements than depicted or described.

In the preceding description, various aspects of the illustrative implementations were described using terms commonly employed by those skilled in the art to convey the substance of their work to others skilled in the art. However, it will be apparent to those skilled in the art that embodiments of the present disclosure may be practiced with only some of the described aspects. For purposes of explanation, specific numbers, materials, and configurations were set forth in order to provide a thorough understanding of the illustrative implementations. It will be apparent to one skilled in the art that embodiments of the present disclosure may be practiced without the specific details. In other instances, well-known features have been omitted or simplified in order not to obscure the illustrative implementations.

In the preceding detailed description, reference is made to the accompanying drawings that form a part hereof, wherein like numerals designate like parts throughout, and in which is shown by way of illustration embodiments in which the subject matter of the present disclosure may be practiced. It is to be understood that other embodiments may be utilized and structural or logical changes may be made without departing from the scope of the present disclosure. Therefore, the detailed description is not to be taken in a limiting sense.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B, and C). More generally, various embodiments may include any suitable combination of the above-described embodiments including alternative (or) embodiments of embodiments that are described in conjunctive form (and) above (e.g., the “and” may be “and/or”). Furthermore, some embodiments may include one or more articles of manufacture (e.g., non-transitory computer-readable media) having instructions, stored thereon, that when executed result in actions of any of the above-described embodiments. Moreover, some embodiments may include apparatuses or systems having any suitable means for carrying out the various operations of the above-described embodiments.

The description may have used perspective-based descriptions such as top/bottom, in/out, over/under, and the like. Such descriptions were used to facilitate the discussion and were not intended to restrict the application of embodiments described herein to any particular orientation.

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

The term “coupled with,” along with its derivatives, may be used herein. “Coupled” may mean one or more of the following. “Coupled” may mean that two or more elements are in direct physical or electrical contact. However, “coupled” may also mean that two or more elements indirectly contact each other, but yet still cooperate or interact with each other, and may mean that one or more other elements are coupled or connected between the elements that are said to be coupled with each other. The term “directly coupled” may mean that two or more elements are in direct contact.

As used herein, the term “module” may refer to, be part of, or include an Application Specific Integrated Circuit (ASIC), an electronic circuit, a processor (shared, dedicated, or group), and/or memory (shared, dedicated, or group) that execute one or more software or firmware programs, a combinational logic circuit, and/or other suitable components that provide the described functionality.

These modifications may be made to the embodiments in light of the above detailed description. The terms used in the following claims should not be construed to limit the embodiments to the specific implementations disclosed in the specification and the claims. Rather, the scope of the invention is to be determined entirely by the following claims, which are to be construed in accordance with established doctrines of claim interpretation.

### EXAMPLES

Example 1 includes an electronic system comprising: a platform that includes a component; one or more ports to communicatively couple with a first debug and test system (DTS) and a second DTS; and logic communicatively positioned between the component and the one or more ports, wherein the logic is configured to: identify, based on a header of a first packet, that the first packet is related to a first debug process of the component, wherein the first debug process is performed by the first DTS; identify, based on a header of a second packet, that the second packet is related to a second debug process of the component, wherein the second debug process is performed by the second DTS; route, based on the identification that the first packet is related to the first debug process, the first packet between the component and the DTS; and route, based on the identification that the second packet is related to the second debug process, the second packet between the component and the DTS.

Example 2 includes the electronic system of example 1, and/or some other example herein, wherein the first packet is related to a read operation or a write operation of the component performed by the first DTS.

Example 3 includes the electronic system of any of examples 1-2, and/or some other example herein, wherein the first debug process and the second debug process at least partially overlap in time.

Example 4 includes the electronic system of any of examples 1-3, and/or some other example herein, wherein if the first debug process is related to a first operation that changes a state of the component, then the logic is further configured to not route the second packet to the DTS if the second process is related to a second operation that changes a state of the component.

Example 5 includes the electronic system of any of examples 1-4, and/or some other example herein, wherein the logic is configured to route the first packet or the second packet based on pre-defined entries in a register set that is related to debug processes of the electronic system that may be performed by a plurality of DTSs.

Example 6 includes the electronic system of any of examples 1-5, and/or some other example herein, wherein the first DTS is physically coupled with the platform.

Example 7 includes the electronic system of any of examples 1-6, and/or some other example herein, wherein the first DTS is wirelessly coupled with the platform.

Example 8 includes the electronic system of any of examples 1-7, and/or some other example herein, wherein the logic is configured to identify that the first packet is related to the first debug process of the component based on an identifier in the header of the first packet, wherein the identifier is related to the first DTS.

Example 9 includes the electronic system of any of examples 1-8, and/or some other example herein, wherein the logic is a first logic, and wherein the component includes a second logic that is configured to manage different debug regions of the component.

Example 10 includes the electronic system of any of examples 1-9, and/or some other example herein, wherein the logic is a first logic, and wherein the component includes a second logic that is configured to virtualize a debug instances.

Example 11 includes the electronic system of any of examples 1-10, and/or some other example herein, wherein the logic is a first logic, and wherein the component includes a second logic that is configured to serialize debug instances.

Example 12 includes a logic for use in an electronic system, wherein the logic is configured to: identify, based on a header of a first packet, that the first packet is related to a first debug process of a component to which the logic is communicatively coupled, wherein the first debug process is performed by a first debugging and testing system (DTS) to which the logic is communicatively coupled; identify, based on a header of a second packet, that the second packet is related to a second debug process of the component, wherein the second debug process is performed by a second DTS to which the logic is communicatively coupled; route, based on the identification that the first packet is related to the first debug process, the first packet between the component and the DTS; and route, based on the identification that the second packet is related to the second debug process, the second packet between the component and the DTS.

Example 13 includes the logic of example 12, and/or some other example herein, wherein the first packet is related to a read operation or a write operation of the component performed by the first DTS.

Example 14 includes the logic of any of examples 12-13, and/or some other example herein, wherein the first debug process and the second debug process at least partially overlap in time.

Example 15 includes the logic of any of examples 12-14, and/or some other example herein, wherein if the first debug process is related to a first operation that changes a state of the component, then the logic is further configured to not route the second packet to the DTS if the second process is related to a second operation that changes a state of the component.

Example 16 includes the logic of any of examples 12-15, and/or some other example herein, wherein the logic is configured to route the first packet or the second packet based on pre-defined entries in a register set that is related to debug processes of the electronic system that may be performed by a plurality of DTSs.

Example 17 includes the logic of any of examples 12-16, and/or some other example herein, wherein the logic is configured to identify that the first packet is related to the first debug process of the component based on an identifier in the header of the first packet, wherein the identifier is related to the first DTS.

Example 18 includes an electronic system comprising: a platform that includes a component; one or more ports to communicatively couple with a first debug and test system (DTS) and a second DTS; and logic communicatively positioned between the component and the one or more ports, wherein the logic is configured to: identify, based on a header of a first packet, that the first packet is related to a first debug process of the component, wherein the first debug process is performed by the first DTS; identify, based on a header of a second packet, that the second packet is related to a second debug process of the component, wherein the second debug process is performed by the second DTS; route, based on the identification that the first packet is related to the first debug process, the first packet between the component and the DTS; and route, based on the identification that the second packet is related to the second debug process, the second packet between the component and the DTS.

Example 19 includes the electronic system of example 18, and/or some other example herein, wherein the first packet is related to a read operation or a write operation of the component performed by the first DTS.

Example 20 includes the electronic system of any of examples 18-19, and/or some other example herein, wherein the first debug process and the second debug process at least partially overlap in time.

Example 21 includes the electronic system of any of examples 18-20, and/or some other example herein, wherein if the first debug process is related to a first operation that changes a state of the component, then the logic is further configured to not route the second packet to the DTS if the second process is related to a second operation that changes a state of the component.

Example 22 includes the electronic system of any of examples 18-21, and/or some other example herein, wherein the logic is configured to route the first packet or the second packet based on pre-defined entries in a register set that is related to debug processes of the electronic system that may be performed by a plurality of DTSs.

Example 23 includes the electronic system of any of examples 18-22, and/or some other example herein, wherein the first DTS is physically coupled with the platform.

Example 24 includes the electronic system of any of examples 18-23, and/or some other example herein, wherein the first DTS is wirelessly coupled with the platform.

Example 25 includes the electronic system of any of examples 18-24, and/or some other example herein, wherein the logic is configured to identify that the first packet is related to the first debug process of the component based on an identifier in the header of the first packet, wherein the identifier is related to the first DTS.

Example 26 includes the electronic system of any of examples 18-25, and/or some other example herein, wherein the logic is a first logic, and wherein the component includes a second logic that is configured to manage different debug regions of the component.

Example 27 includes the electronic system of any of examples 18-26, and/or some other example herein, wherein the logic is a first logic, and wherein the component includes a second logic that is configured to virtualize a debug instances.

Example 28 includes the electronic system of any of examples 18-27, and/or some other example herein, wherein the logic is a first logic, and wherein the component includes a second logic that is configured to serialize debug instances.

Example Z01 may include an apparatus comprising means to perform one or more elements of a method described in or related to any of the examples herein, and/or any other method, process, or technique process described herein, or portions or parts thereof.

Example Z02 may include an apparatus comprising logic, modules, or circuitry to perform one or more elements of a method described in or related to any of the examples herein, and/or any other method, process, or technique described herein, or portions or parts thereof.

Example Z03 may include a method, technique, or process as described in or related to any of the examples herein, and/or any other method, process, or technique described herein, or portions or parts thereof.

Example Z04 may include a signal as described in or related to any of the examples herein, and/or any other method, process, or technique described herein, or portions or parts thereof.

Example Z05 may include an apparatus comprising one or more processors and non-transitory computer-readable media that include instructions which, when executed by the one or more processors, are to cause the apparatus to perform one or more elements of a method described in or related to any of the examples herein, and/or any other method, process, or technique described herein, or portions or parts thereof.

Example Z06 may include one or more non-transitory computer readable media comprising instructions that, upon execution of the instructions by one or more processors of an electronic device, are to cause the electronic device to perform one or more elements of a method described in or related to any of the examples herein, and/or any other method, process, or technique described herein, or portions or parts thereof.

Example Z07 may include a computer program related to one or more elements of a method described in or related to any of the examples herein, and/or any other method, process, or technique described herein, or portions or parts thereof.

1. An electronic system comprising:
a platform that includes a component;
one or more ports to communicatively couple with a first debug and test system (DTS) and a second DTS; and
logic communicatively positioned between the component and the one or more ports, wherein the logic is configured to:
identify, based on a header of a first packet, that the first packet is related to a first debug process of the component, wherein the first debug process is performed by the first DTS;
identify, based on a header of a second packet, that the second packet is related to a second debug process of the component, wherein the second debug process is performed by the second DTS;
route, based on the identification that the first packet is related to the first debug process, the first packet between the component and the DTS; and
route, based on the identification that the second packet is related to the second debug process, the second packet between the component and the DTS.

2. The electronic system of claim 1, wherein the first packet is related to a read operation or a write operation of the component performed by the first DTS.

3. The electronic system of claim 1, wherein the first debug process and the second debug process at least partially overlap in time.

4. The electronic system of claim 1, wherein if the first debug process is related to a first operation that changes a state of the component, then the logic is further configured to not route the second packet to the DTS if the second process is related to a second operation that changes a state of the component.

5. The electronic system of claim 1, wherein the logic is configured to route the first packet or the second packet based on pre-defined entries in a register set that is related to debug processes of the electronic system that may be performed by a plurality of DTSs.

6. The electronic system of claim 1, wherein the first DTS is physically coupled with the platform.

7. The electronic system of claim 1, wherein the first DTS is wirelessly coupled with the platform.

8. The electronic system of claim 1, wherein the logic is configured to identify that the first packet is related to the first debug process of the component based on an identifier in the header of the first packet, wherein the identifier is related to the first DTS.

9. The electronic system of claim 1, wherein the logic is a first logic, and wherein the component includes a second logic that is configured to manage different debug regions of the component.

10. The electronic system of claim 1, wherein the logic is a first logic, and wherein the component includes a second logic that is configured to virtualize a debug instances.

11. The electronic system of claim 1, wherein the logic is a first logic, and wherein the component includes a second logic that is configured to serialize debug instances.

12. A logic for use in an electronic system, wherein the logic is configured to:
identify, based on a header of a first packet, that the first packet is related to a first debug process of a component to which the logic is communicatively coupled, wherein the first debug process is performed by a first debugging and testing system (DTS) to which the logic is communicatively coupled;
identify, based on a header of a second packet, that the second packet is related to a second debug process of the component, wherein the second debug process is performed by a second DTS to which the logic is communicatively coupled;
route, based on the identification that the first packet is related to the first debug process, the first packet between the component and the DTS; and
route, based on the identification that the second packet is related to the second debug process, the second packet between the component and the DTS.

13. The logic of claim 12, wherein the first packet is related to a read operation or a write operation of the component performed by the first DTS.

14. The logic of claim 12, wherein the first debug process and the second debug process at least partially overlap in time.

15. The logic of claim 12, wherein if the first debug process is related to a first operation that changes a state of the component, then the logic is further configured to not route the second packet to the DTS if the second process is related to a second operation that changes a state of the component.

16. The logic of claim 12, wherein the logic is configured to route the first packet or the second packet based on pre-defined entries in a register set that is related to debug processes of the electronic system that may be performed by a plurality of DTSs.

17. The logic of claim 12, wherein the logic is configured to identify that the first packet is related to the first debug process of the component based on an identifier in the header of the first packet, wherein the identifier is related to the first DTS.

18. An electronic system comprising:
a platform that includes a component;
one or more ports to communicatively couple with a first debug and test system (DTS) and a second DTS; and
logic communicatively positioned between the component and the one or more ports, wherein the logic is configured to:
identify, based on a header of a first packet, that the first packet is related to a first debug process of the component, wherein the first debug process is performed by the first DTS;
identify, based on a header of a second packet, that the second packet is related to a second debug process of the component, wherein the second debug process is performed by the second DTS;
route, based on the identification that the first packet is related to the first debug process, the first packet between the component and the DTS; and
route, based on the identification that the second packet is related to the second debug process, the second packet between the component and the DTS.

19. The electronic system of claim 18, wherein the first packet is related to a read operation or a write operation of the component performed by the first DTS.

20. The electronic system of claim 18, wherein the first debug process and the second debug process at least partially overlap in time.
